(19) United States
(12) Patent Application Publication
(10) Pub. No.: US 2026/0251443 A1
(43) Pub. Date: Aug. 27, 2026

(54) METHOD AND APPARATUS FOR MONITORING A ROLLER FOR A ROLLER PRESS, AS WELL AS A ROLLER PRESS SYSTEM

(71) Applicant: Maschinenfabrik Köppern GmbH & Co. KG, Hattingen (DE)

(72) Inventors: Eggert DE WELDIGE, Velbert Langenberg (DE); Max BUCHMEIER, Wuppertal (DE); Julius ORTMANNS, Bochum (DE)

(73) Assignee: Maschinenfabrik Köppern GmbH & Co. KG, Hattingen (DE)

(21) Appl. No.: 19/449,534

(22) Filed: Jan. 15, 2026

(30) Foreign Application Priority Data
Feb. 26, 2025 (DE) 10 2025 107 221.3

(51) Int. Cl. G01B 11/24; B30B 11/00

(52) U.S. Cl. CPC G01B 11/24; B30B 11/006

(57) ABSTRACT

A method for monitoring a three-dimensional structure of a surface of a roller for a roller press for comminuting, briquetting or compacting, having a monitoring device that determines the surface structure of the roller by distance measurements. During the distance measurements, at least one three-dimensional reference means is affixed to the surface of the roller, within the working width of the roller.

### CROSS REFERENCE TO RELATED APPLICATIONS

Applicant claims priority under 35 U.S.C. §119 of German Application No. 10 2025 107 221.3 filed Feb. 26, 2025, the disclosure of which is herein incorporated by reference.

### BACKGROUND OF THE INVENTION

### 1. Field of the Invention

The invention relates to a method for monitoring a three-dimensional structure of a surface of a roller for a roller press, for example a high-pressure roller press for comminuting, briquetting or compacting material, having a monitoring device that determines the surface structure of the roller (three-dimensionally) by means of distance measurements.

Furthermore, the invention relates to an apparatus for monitoring a three-dimensional structure of a surface of a roller for a roller press, with which apparatus such a method is carried out or can be carried out, as well as to a roller press system having a roller press, the roller or rollers of which are monitored using such a method.

### 2. Description of the Related Art

A roller press, for example a high-pressure roller press for comminuting material is also referred to as a high-compression roller mill. In the case of high-compression roller mills, the individual particles of the applied material are not broken between the surfaces of the two rollers, as in the case of a breaker, but rather they are pressed under high pressure, in a product bed or material bed, and thereby comminuted in a highly efficient manner. The material is, in particular, highly abrasive material, for example ore, cement clinker, slag, or basic ceramic materials.

The roller press can also be intended for compacting or briquetting of material, for example for compacting of fertilizer. In a compacting press, the material is compacted in the roller gap, between rollers having a structured surface, at great pressure, to produce a continuous material strand, which is referred to as a ribbon. In a briquetting press, the material is compacted in the roller gap by means of the briquetting tools that are arranged on the roller surfaces (with briquette depressions to form briquettes or a briquette strand composed of a plurality of briquettes). Briquetting takes place, for example, also for the production of briquettes from directly reduced iron (DRI) or for the production of hot briquetted iron (HBI).

The roller press has two rollers driven to rotate (in opposite directions), called press rollers or working rollers, between which a roller gap is formed. The gap width of the roller gap can change during operation of the press. For this purpose, one of the press rollers can be configured as a fixed roller, and the other one as a loose roller, wherein the loose roller can be set against the fixed roller by way of force production means. The outside diameter of the rollers decreases during the production operation, due to wear.

The press rollers can, for example, each have a roller core and a bandage arranged on the roller core, the outside diameter of which bandage decreases during operation, due to wear. In the case of such an embodiment, the roller surfaces that are subject to wear are consequently formed by the bandages. Wear-protection elements can be worked into the surface. The wear-protection elements can be configured, for a comminuting roller, in pin form, as what are called studs, or in plate form, as what are called tiles. Furthermore, the roller can have special edge-protection elements.

In total, the rollers of the roller press can have different surface structures. These include not only the briquette depressions of a briquetting roller but also different compacting structures of a compacting roller. Furthermore, comminuting rollers are included, which have special wear layers having wear-protection elements, such as pin-shaped or plate-shaped elements. All of these different three-dimensional surface structures of a roller for a roller press are included in the present invention.

From practice, it is known to monitor the state of the surfaces of the rollers of a roller press, so as to check the wear state and to derive appropriate measures from it, so as to ensure problem-free operation of the press and to avoid problems or interruptions in operation. In the case of a comminuting roller, it is important to monitor the presence and the state of the wear-protection elements; in the case of a briquetting roller, to monitor the state of the corresponding briquette depressions; and in the case of a compacting roller, to monitor the state of the compacting structures.

From WO 2022/023869 A1, a wear-detection apparatus for detecting the wear of a roller is known. This apparatus has a scanning sensor that is connected to a controller and scans a section of the surface so as to determine possible wear or the complete absence of wear elements of the roller surface. Furthermore, the apparatus has an additional orientation sensor that serves to detect a reference marking on the roller, so as to determine the relative position of the scanning sensor relative to the roller. This reference marking is configured as a depression or as a projection on the surface of the roller.

Furthermore, from WO 2014/068453 A1, an apparatus for monitoring the surface of a roller of a roller crusher is known, in which a light sensor is arranged in such a manner that it projects a line onto the surface of the roller. An additional image detection apparatus detects an image of a section of this surface, which section also contains part of the projected line. Using a processor unit, the detected image is processed, so as to obtain information about the surface of the roller. Furthermore, a plurality of images is recorded at different rotational positions of the roller, so as to be able to represent the entire roller, if possible.

Furthermore, WO 2008/090016 A1 describes a roller mill having two grinding rollers that are driven to move in opposite directions and are equipped with a plurality of profile bodies. Using a monitoring apparatus, the presence or absence of these profile bodies is determined, so as to prevent downtimes. For this purpose, a sensor is used, which checks the roller mill during grinding operation and counts the detected profile bodies. This sensor can be moved parallel to the axis of the grinding roller.

Also, from DE 20 2015 106 156 U1 a roller mill having two rotating rollers is known, wherein a roller to be measured has a sensor unit assigned to it, which unit measures the distance to the grinding surface of this roller during operation of the roller mill, so as to be able to draw conclusions regarding the wear state of the rollers by means of an evaluation unit.

WO 2023/104294 A1 describes a roller machine for crushing or compacting applied material, having at least one roller, wherein the roller has a plurality of impact elements and/or edge-protection elements on the outer surface. A radar unit is provided on this roller machine, which unit emits a radar beam onto the outer surface of the roller, which beam is reflected at the stated elements, and thereby the state of these elements can be monitored.

Furthermore, from DE 10 2022 134 175 A1 an apparatus for measuring the wear of a roller of a high-pressure roller press is known. The wear is determined from the quotient of the surface velocity and the angular velocity of the roller, wherein the circumference and the diameter of the roller can be calculated from this. For this purpose, a movable sensor for measuring the surface velocity is used over the length of the roller, along with an angular velocity measurement device that interacts with a shaft of the roller. The sensor can be a laser sensor, which works according to the differential Doppler method, and the angular velocity measurement device can be configured as a Hall Effect sensor that is excited by way of a magnet.

Finally, from DE 21 2021 000 130 U1, an apparatus for detecting defects on the roller surface of a roller press is known. This apparatus utilizes a 3D scanner for detecting three-dimensional point cloud data of the roller surface. By way of determining the change in the height values, it is possible to draw conclusions regarding the wear of the roller.

### SUMMARY OF THE INVENTION

Proceeding from the previously known prior art, the invention is based on the technical problem of creating a method and an apparatus, in connection with (high-pressure) roller presses, which presses are intended for comminuting, compacting or briquetting material, which method and/or apparatus make/makes reliable monitoring of the three-dimensional structure of the surface of a roller possible, using simple means, over the entire width, i.e., the working width of the roller. It should be possible to use the method and/or the apparatus in a particularly flexible manner and with little expenditure and effort regarding the system and installation.

To accomplish this task, the invention teaches, in the case of a method for monitoring the surface structure of a roller of the stated type, that during the distance measurements, at least one three-dimensional reference means is affixed on the surface of the roller within the working width of the roller.

In this regard, the invention proceeds from the recognition that monitoring a three-dimensional surface structure of a roller can easily be carried out using distance measurements. Proceeding from this, the invention proposes the use of at least one three-dimensional reference means that is affixed to the roller surface (for example temporarily) within the working width of the roller, and is also measured during the measurement, within the working width, using the monitoring device. This three-dimensional reference means serves as a reference or as a reference point for the monitoring apparatus during the distance measurements, and simplifies and optimizes the evaluation. Since the reference means itself – just like the surface structure of the roller – also has a characteristic three-dimensional structure, it can be excellently detected using the (same) monitoring device, and taken into consideration in the evaluation. The use of such a reference means makes optimal standardization and/or scaling of the measurement data and/or of the 3D image data set possible, in particular, for example even when using a mobile measurement arrangement. Furthermore, the reference means can make it possible, on the one hand, to monitor irregular surface structures, and, on the other hand, to also measure greater widths of a roller. This will still be discussed in greater detail during the further course of the specification. It is furthermore particularly advantageous that the reference means is recorded by the monitoring device, for example its measuring device, directly together with the entire surface structure, and thereby no additional device is necessary to detect and evaluate the/a reference marking.

It is particularly advantageous that/if the three-dimensional geometry of the reference means, i.e. the geometry in the X, Y, and Z direction, is stored in memory as a three-dimensional reference data set (for example in the monitoring device). During measurement of the roller surface, not only does measurement of the surface structure to be investigated take place, but, in particular, measurement of this reference means also takes place, so that with the measurement of the reference means, what is called a scaling measurement data set is produced. During the course of the evaluation, the 3D image data set that represents the surface structure of the roller is then scaled, taking into consideration this recorded scaling measurement data set and taking into consideration the reference data set stored in memory. The scaling measurement data set is the data set that is produced during the actual measurement of the reference means, so that on the basis of the reference data set stored in memory, on the one hand, and the scaling measurement data set produced by measuring, on the other hand, scaling can take place, for example in that scaling factors are produced, with which the 3D image data set that represents the surface structure of the roller is scaled. These measures have the advantage that during the measurements, i.e., during monitoring of the roller surface, defined positioning of the monitoring device relative to the roller surface is not important. Consequently, it does not matter if the monitoring device and/or the distance and/or the angle of source and sensor relative to the roller are the same during every measurement. By having knowledge of the geometry of the reference means in every image data set, it is possible to calculate out all the angle and size distortions that result from different orientations or distances of the measurement device from the roller, so that a dimensionally accurate and angle-true image of the entire roller surface is obtained. The reference means consequently serves, above all, for clear scaling and therefore standardization of the measurement data, which procedures are generally carried out by means of measurements at time intervals and in different positions of the source and/or of the sensor. Furthermore, the reference means, i.e., the detection of the known geometry of the reference means, also makes it possible to measure roller surfaces having a greater width, which is greater than the measurement width of the monitoring device, for example. This will still be discussed in detail below.

The monitoring device can be a known measurement system that is suitable for producing a three-dimensional recording of a structured surface, using distance measurements. In this regard, the monitoring device can not only carry out the measurement but also (directly) process the data obtained from the measurement, evaluate them, and create the 3D image data set and/or a three-dimensional image, in the sense of an evaluation unit. Alternatively, a separate evaluation unit can also be used, which communicates with the monitoring device and processes the measurement values further. Furthermore, a computer can be connected to the monitoring device and/or the evaluation unit, or such a computer can be a component of the monitoring device. Preferably, consequently at least the described sensor device is a component of the monitoring device positioned on the roller. Optionally, an evaluation unit can also be integrated into the monitoring device, wherein the reference data set required for scaling is stored in memory in the monitoring device, in the (internal) evaluation unit, for example. If the evaluation unit is not a component of the (mobile) monitoring device, but rather is implemented as an external evaluation unit, for example by means of a separate computer, the reference data set is preferably stored not in the monitoring device but rather in the separate evaluation unit. In this regard, the evaluation unit can be implemented by means of a separate computer and consequently by means of separate hardware. However, the invention also comprises embodiments in which the evaluation unit is implemented on a separate (external) server or in a Cloud, so that then the evaluation unit is implemented, for example, as an evaluation algorithm or a Job in a Cloud, and also the reference data set is stored on a separate server or in a Cloud, for example.

Preferably, the at least one reference means is releasably affixed to the roller, for example adhesively or magnetically. Thereby the reference means can be reversibly affixed to the roller surface in order to carry out the distance measurements by means of the monitoring device. Before the roller is used again in production operation, after monitoring of the surface, for example, the releasably attached reference means is removed from the surface of the roller. In order to make this possible, the reference means can be adhesively affixed, i.e., it can be glued on, for example as an adhesive reference sticker or by means of an additional adhesive that can be released again, for example by heating it. Alternatively, the reference means can be configured magnetically and affixed to the metallic roller by way of a magnetic connection. Alternatively, the reference means can also be fastened to the roller surface by means of wedging (for example between the wear elements, for example studs) or by setting it on (for example onto the wear elements, for example studs). Thereby rapid and flexible placement onto and/or removal from the roller surface is possible for the reference means. This is important because the reference means is preferably attached to the roller surface (namely within the working width) only during the monitoring process, and removed during press operation.

This is because the method for monitoring the surface structure is preferably not carried out during production operation, i.e., press operation of the roller or press, but rather during an interruption of operation, particularly preferably, however, in a state of the roller when it is installed in a press. As compared with the previously known prior art, this has the advantage that carrying out such measurements is not impaired by the conditions during ongoing production operation. Monitoring can thereby take place in a particularly simple manner and with great accuracy. It is advantageous if measuring takes place during maintenance operation or some other shutdown in production. Nevertheless, the roller can be monitored while it is installed in the press, in that the reference means is affixed to the roller surface and the monitoring device is positioned in the region of the roller to be measured. Alternatively, the roller can also be removed from the press in order to carry out the distance measurement, and can be measured in a special test stand, for example.

In a preferred embodiment, the roller rotates during monitoring of the three-dimensional surface structure, and preferably does so at a uniform rotation speed. The monitoring device can thereby carry out distance measurements – even with a limited measurement range – over the entire circumference of the roller, and thereby determine the surface structure of the entire roller, i.e., over the entire roller circumference. It makes sense that the roller rotates at a uniform speed so as to avoid possible errors such as, for example, distorted representations of the surface. If it is a question of uniform structures on the roller surface, however, varying speeds of rotation can be accepted. A non-uniform representation of the actually regular structure, which representation results from varying speeds, can be corrected by the evaluation unit, since the regular structure is known. When measuring irregular surface structures, on the other hand, it is advantageous, so as to achieve perfect results, if the roller rotates at a uniform speed during monitoring of the surface structure.

By means of the distance measurements, it is possible to create complete three-dimensional information (as a 3D image data set) over the circumference and over at least part of the working width of the roller, and optionally also a three-dimensional image (as a graphic representation or visualization) of the surface structure of the roller. The roller surface can be recorded in part or entirely, and can be represented graphically, for example. The recorded data and/or the representation of the surface in 3D permit/permits reliable conclusions regarding the wear of the surface. This is because when using the three-dimensional data and/or representation, differences in the height of the surface and thereby differences in the wear of the roller can be recognized. The three-dimensional data set and/or the three-dimensional image of the surface are either produced by the monitoring device (with integrated evaluation unit) and optionally output, or produced by a separate evaluation unit that communicates with the monitoring device and receives the (raw) data of the distance measurements from it. The graphic representation of the surface can alternatively take place on a computer connected to the monitoring apparatus.

Preferably, the monitoring device has at least one sensor device, wherein the sensor device has a source, for example a radiation source, that generates a measurement beam, and wherein the sensor device has a detector or sensor or receiver (reception element) that detects the measurement beam, for example a beam of light, generated by the source and reflected by the surface of the roller.

The measurement beam is preferably a beam of electromagnetic radiation projected onto the roller surface, for example a beam of light, which can be visible light. Alternatively, however, electromagnetic radiation outside of the visible spectrum, for example IR or UV radiation, is also detected. The sensor device is set up for reception of the measured radiation, for example of the light. By means of detection of the beams reflected by the roller surface, it is possible to determine the distance of the point on the surface that is to be measured, in each instance, for example by means of triangulation. This will still be discussed below.

In a particularly preferred embodiment, the source projects the measurement beam as a measurement line that is oriented along the roller width, onto the roller surface, for example as a laser line, wherein preferably the length of the measurement line, for example of the laser line, which length extends along the roller width (for example in an X direction oriented parallel to the roller axis), defines the measurement width of the sensor device and/or of the monitoring device. The sensor device can consequently be configured as a line scanner, for example a laser line scanner, which preferably makes use of the laser triangulation principle for detecting the surface profiles on the roller surface. For this purpose, suitable optics, for example line optics, can project a line, for example a laser line, onto the roller surface. The (diffusely) reflected light of this line, for example laser line, is imaged onto the detector/sensor of the sensor device, for example by way of suitable optics. In this regard, the detector can allow a position-resolved measurement, for example, as a sensor matrix, for example, so that the spatial position of the light reflected by the laser line (in the width direction) can be detected. The production and measurement of such a measurement line, for example laser line, for example using a laser line scanner, first of all allows two-dimensional detection, in that the distance data (for example as a Z axis oriented in the radial direction) are detected by way of a width position along the measurement line (as the X axis). A 3D image or three-dimensional record of the roller surface then takes place by means of moving the roller surface relative to the measurement device or sensor device, and consequently by means of rotating the roller, so that the roller surface moves along a Y axis (oriented in the circumference direction or in the tangential direction) relative to the measurement device. In this way, a 3D point cloud is obtained from stringing together the 2D profiles determined by way of the line detection (in the X direction).

In a preferred embodiment of the invention, the distance measurements are carried out by means of triangulation, preferably by means of laser triangulation. Triangulation is a distance measurement by means of angle calculation in the sense of depth image detection. The measurement beam, for example a laser beam, is projected onto the object to be measured, in the case of the present invention, therefore onto the surface of the roller. The reflected light impacts a receiver as a function of the distance from the surface or from the object to be determined, at a specific angle. The distance from the measured object is calculated by means of the position of the reflected beam on the receiver, i.e., reception element and the distance between the transmitter and the reception element. As an alternative to a laser, other light sources can also be used, such as, for example, diodes. Alternatively, it is possible to work with a “LIDAR system.” “LIDAR” stands for “Light Detection and Ranging” or “Light Emerging, Detection and Ranging.”

It is particularly advantageous if the sensor device projects a (strip-shaped) measurement line, for example a laser line, onto the roller surface – as described – which line has a length that defines the measurement width M of the measurement device and extends along the width of the roller (i.e., parallel to its axis). This makes it possible for the roller surface to be measured over a specific measurement width (in one measurement procedure and thereby one image data set). By way of the positioning of the monitoring device, measuring the specific measurement region having the measurement width M is made possible.

The monitoring apparatus, i.e., its sensor device, can have a measurement width M that is less than the working width b of the roller, wherein for recording the entire working width of the roller, multiple distance measurements have to be carried out over the circumference, in each instance, one after the other, at different width positions of the roller, which positions cover the at least one reference means. Therefore, the measurement width of the monitoring apparatus can be smaller than the working width of the roller. In practice, the rollers and, in particular, also the wear region, i.e., the working width, are often wider than the measurement range of common measurement systems, and therefore of the monitoring apparatus, which can only cover a specific width region of the roller at a predetermined positioning of the measurement system. To detect and monitor the entire working width of the roller, multiple distance measurements can be carried out over the working width of the roller, wherein the monitoring apparatus does not traverse in this regard, but rather is in a fixed location during each record-taking. Accordingly, the monitoring apparatus can carry out multiple distance measurements of the type described, at different positions along the working width, one after the other. The reference means, which is situated on the surface of the roller, in each instance, is recorded by the monitoring apparatus for orientation and determination of the position of the corresponding measurements. The three-dimensional reference means according to the invention consequently has particular importance when roller surfaces having a working width that is greater than the measurement width of the sensor device being used are supposed to be measured. By way of the reference means, it is possible to “combine” the measurement data that were obtained, one after the other, at different width positions, to produce an image or data set of the entire roller surface. The reference means according to the invention consequently makes it possible to measure press rollers having usual roller widths that can also be (clearly) wider than the stated measurement width, even using known measurement devices having a limited measurement width of 10 cm to 50 cm, for example, preferably 20 cm to 40 cm. This is made possible using very simple means, for example in that the measurement device is positioned or oriented in different positions, as a mobile sensor device, without particularly great precision of the positioning of the measurement device being important, in this regard, since standardization or scaling of the measurement data takes place by way of the reference means, on the roller surface, in the form of 3D image data sets. This is because, in order to record larger working widths, multiple 3D image data sets are produced one after the other, according to the invention, wherein the multiple distance measurements overlap in at least one overlap region in which the reference means is arranged. The multiple 3D image data sets that are produced over the working width are combined, taking into consideration the reference data set stored in memory and the scaling data set recorded at the reference means, and scaled identically. In this regard, as well, it is important that the three-dimensional structure of the reference means is known and stored, for example, in the memory of the monitoring device as a reference data set. During the measurement, not just the structures of the roller surface that are to be examined, but rather, in particular, also the reference means, are measured and thereby a scaling data set is produced, which allows combining the image data sets that have been obtained, one after the other, during the course of the evaluation, and thereby allows identical scaling.

Preferably, consequently, multiple measurements that overlap in a region are carried out to create the three-dimensional image of the surface structure of the entire working width of the roller, wherein the at least one reference means is affixed in this overlap region. This means serves to make it possible to subsequently represent the entire working width of the roller in a single three-dimensional view for evaluation. The reference means serves, in this regard – as described – for orientation or standardization/scaling of the measurement data. Because of the fact that in overlapping records or measurements of the surface, the reference means is also recorded in the overlap region, regions that have been measured twice can be calculated out, so that the entire 3D data set of the roller surface and thereby the overall image of the roller is obtained. The reference means additionally serves, in this case, for allocating multiple measurements or measurement regions of the surface, so as to combine the pictures of the surface of the roller into an overall image, i.e., as an overall data set.

In one embodiment, the monitoring device is fastened in place during monitoring of the three-dimensional surface structure, i.e., it is mounted in a fixed location. It is true that it can be configured to be mobile, but it is not moved during the measurement/data recording. As compared to a measurement device that traverses a rail, for example, the monitoring device according to the invention has the advantage that it does not move within the (working) width of the roller while the distance measurements are being carried out. As a result, the measurement accuracy is increased, and the measurement process is simplified. The monitoring apparatus is consequently operated in a stationary manner during each measurement. This means that positioning of the monitoring device in a fixed location takes place, which positioning is not changed while carrying out the distance measurements, while the roller is rotating. The monitoring device can be moved solely for further distance measurements, for example one after the other over the working width of the roller.

In an advantageous embodiment of the invention, the at least one three-dimensional reference means is configured, in cross-section, as a step-shaped reference means, for example as a step-shaped pyramid, wherein the steps can have a different height and/or width, in each instance. The defined geometry of the reference means, which is known to the system (i.e., to the evaluation unit), is detected by the monitoring device, in other words distance measurements are carried out also on the reference means, which measurements are taken into consideration in the evaluation and are used for scaling/standardization of the measurement data. The present invention is not, however, restricted to the geometry described and, in general, also not just to a symmetrical geometry of the reference means.

Preferably, the at least one three-dimensional reference means is configured asymmetrically in a top view, for example with an asymmetrically configured corner region. On the basis of the asymmetry, i.e., an asymmetrical region – for example in a corner – the orientation of the reference means and thereby, for example, the direction of rotation of the roller during the measurement can be reliably determined.

Within the scope of the invention, multiple three-dimensional reference means (of the type described) can be arranged on the surface of the roller and distributed over the working width b of the roller at a distance from one another. The multiple reference means can optionally differ in their geometry, in each instance. In order to measure rollers having a greater working width, which rollers are many times wider than the measurement range of the monitoring device, multiple three-dimensional reference means are arranged in the overlap region of the measurements, in each instance, which means serve not only for scaling/standardization but also for orientation and attribution during the evaluation. In order to make it possible to differentiate the individual recorded reference means from one another, they have different geometries. This means that in the case of the step-shaped embodiment as a pyramid, for example, different reference means each can have different widths, heights or outlines in the individual steps.

In a further embodiment of the invention, for an absolute measurement of the surface, for example an absolute determination of the wear, in addition at least one additional reference device can be provided outside of the working width of the roller, which device is arranged, for example, in an edge region on the roller circumference, on the end face of the roller, or on the press frame. To carry out absolute measurements, the additional reference device is arranged in a region that is not subject to any wear, in other words it is not arranged in the wear region to be examined, and consequently not within the working width of the roller. This reference device is nevertheless detected by the same monitoring device, preferably the same sensor device, and serves as an absolute reference of the evaluation of the surface structure. The absolute measurement consequently takes place relative to the absolute reference device, by means of measuring the one or more three-dimensional reference means of the related sections of the roller surface within the working width of the roller. The reference device arranged outside of the working region should consequently be differentiated from the reference means (singular and plural) that is/are (temporarily) arranged in the working region of the roller.

The object of the invention is not just the method described, but rather also an apparatus for monitoring a three-dimensional structure of a surface of a roller for a roller press for comminuting, briquetting or compacting, having a monitoring device and at least one three-dimensional reference means, wherein the at least one reference means can be fastened in place within the working width of the roller, on the surface of the roller. The combination of monitoring device and reference means consequently has particular importance.

All of the preferred embodiments and characteristics of the invention mentioned in connection with the method also apply to the apparatus according to the invention.

Preferably, the monitoring device is configured to be mobile, i.e., transportable. Consequently, it does not need to be an integral component of the press or press system, but rather can be positioned in the region of the press or its roller for the purpose of taking a measurement, and removed again after the measurement has been carried out. Alternatively, the mobile monitoring device can also be mounted on a separate test stand into which the roller is installed for the (distance) measurements. In any case, the monitoring device can be flexibly positioned on the basis of the transportable embodiment, for carrying out the measurements, and it is not permanently affixed to the roller press, in order to protect it from damage also during operation of the press (during which no measurements take place). The mobile embodiment is advantageous, above all, for measuring large roller widths using multiple measurements in different positions.

The monitoring device according to the invention and the reference means used in this connection are consequently of particular importance also within the claimed press system. With regard to the embodiment and function of the monitoring device and with regard to the optional and preferred embodiments, reference is made here to the explanations regarding the described method and the described monitoring apparatus.

The present invention also comprises a roller press system having a roller press having two rollers mounted to rotate in a press frame, between which rollers a roller gap is formed, and having at least one three-dimensional reference means as well as a monitoring device for monitoring the three-dimensional structure of the surface of the roller, wherein the at least one reference means can be affixed within the working width of one of the rollers, on the surface of this roller. The monitoring device is consequently placed under protection, particularly preferably in combination with the roller press.

The characteristics that relate to the method as well as to the apparatus also apply to the roller press system.

In a preferred embodiment, the roller has a regular surface structure, in each instance, over the width and/or the circumference. By means of a regular structure of the surface, i.e., one that recurs over the width and/or the circumference, the orientation on the roller surface, i.e., the compilation of individually recorded three-dimensional images is additionally facilitated. For example in the case of a briquetting press, which has corresponding depressions on the surface of the rollers, the formation and arrangement of these depressions is generally uniform. The wear-protection elements of comminution rollers can also have a regular formation and placement on the surface of the rollers.

The roller can be configured as a briquetting or compacting roller having a depression-shaped surface structure, or as a comminution roller having pin-shaped or plate-shaped wear-protection elements. The monitoring apparatus can measure not only the depressions, but also the wear-protection elements, such as “studs,” for example, in the case of “stud-lining”. On the basis of the distance measurements that are carried out, it is possible, for example, to determine the wear of the corresponding surface structure of the roller.

According to the invention, the at least one three-dimensional reference means, as described, which is not subject to wear and is affixed or has been affixed during the distance measurements (for example temporarily), within the working width of the roller, on the surface of the roller, specifically preferably in a releasable manner, is of particular importance. This reference means is not only subjected to stress – as described – in combination with the monitoring device, but also in an isolated manner and, alternatively, also in combination with a press roller of a roller press of the type described. The invention consequently also relates to a press roller of a roller press for comminuting, briquetting or compacting of material, wherein at least one three-dimensional reference means of the described type (not subject to wear) can be affixed or has been affixed to the surface of the press roller within the working width. The combination of a fundamentally known press roller, on the one hand, and the reference means according to the invention (or multiple such reference means), on the other hand, is consequently also being placed under protection as a press roller or press roller assembly according to the invention. The reference means itself can be configured in the manner described. To avoid repetition, reference is made to the preferred embodiments of the reference means, which have been described in connection with the claimed method, the claimed apparatus, and the claimed press system. All of the characteristics of the reference means that have been described or claimed are also being claimed in isolation and in the combination of the reference means with or on a press roller.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows a roller press in a simplified side view;

FIG. 2 shows a roller, i.e., roller surface with the apparatus for monitoring, according to the invention;

FIG. 3 shows an embodiment of a reference means according to the invention, in a side view; and

FIG. 4 shows a three-dimensional representation of the surface structure of a roller.

### DETAILED DESCRIPTION OF PREFERRED EMBODIMENTS

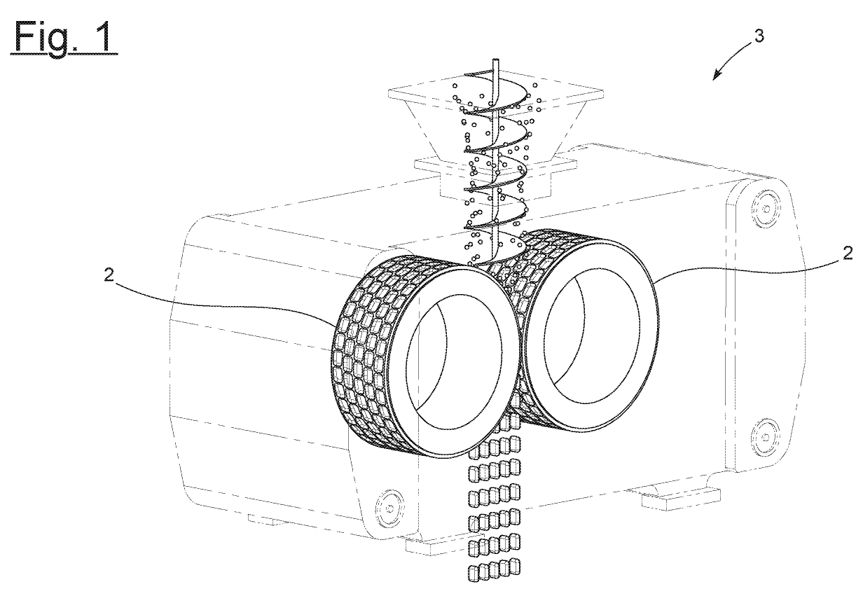

In FIG. 1, a roller press 3, for example a high-pressure roller press, is shown, which has two press rollers 2 that rotate in opposite directions (shown in a simplified manner with their roller surface). A roller gap is arranged between the press rollers, wherein the gap width of the roller gap can be changed during operation of the roller press 3. This is because one of the press rollers is configured as a fixed roller, and the other press roller is configured as a loose roller, wherein the loose roller can be adjusted against the fixed roller by way of force production means, for example hydraulically, so that the gap width changes during operation, within certain limits.

The material to be processed is supplied from above, for example by way of an application shaft, and drawn into the pressure zone by means of the opposite rotation of the press rollers 2. There the material can be comminuted, briquetted or compacted under the effect of the existing pressure – depending on the application case and embodiment.

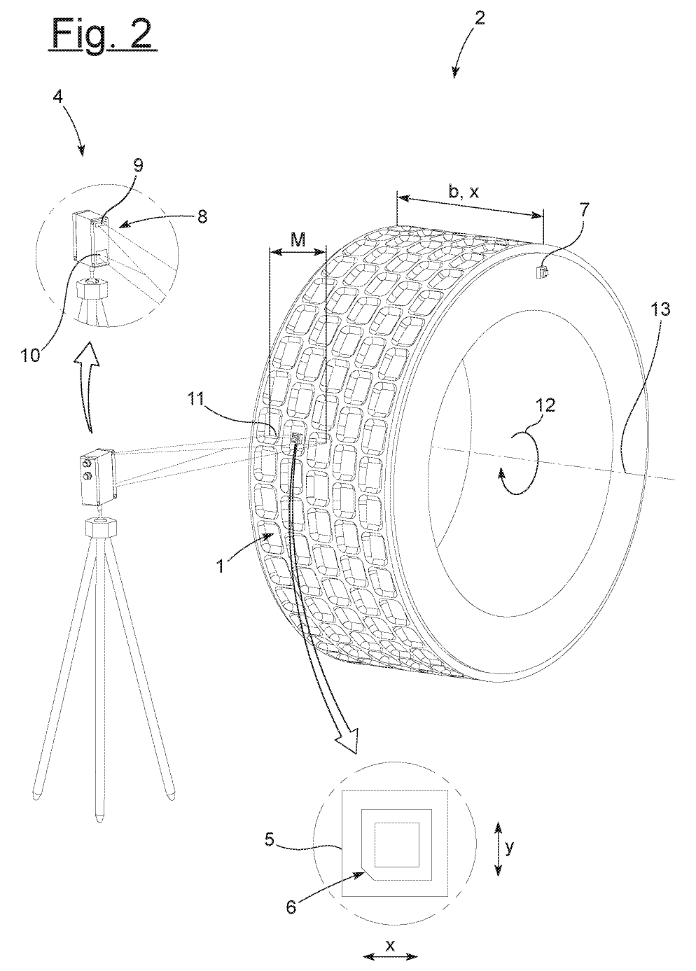

FIG. 2 shows (in simplified form) one of the press rollers 2 of the roller press 3, wherein the three-dimensional surface structure 1 of the roller surface can be recognized. If the roller is configured as a briquetting or compacting roller, it has a depression-type surface structure, as shown in simplified form in FIG. 2. In the case of the embodiment of the roller as a comminution roller of a high-compression roller mill, the roller can be equipped with pin-shaped or plate-shaped wear-protection elements. Such a wear-protection layer is not shown in the figures. Nevertheless, the invention also comprises this embodiment of the surface of a roller. In this regard, the three-dimensional surface structure of the roller can be configured to be regular as well as irregular.

The three-dimensional surface structure 1 of the roller 2 extends over the entire working width b of the roller 2, which width can, however, be less than the total width of the roller. The surface structure 1, which also forms the wear region, is detected by the monitoring device 4. This monitoring device 4 has an electromagnetic radiation source 9, for example a laser, which projects a beam 8 onto the surface, which beam is reflected by the surface structure 1 and recorded by a receiver 10, for example in the monitoring device 4. This is shown schematically in FIG. 2. By means of triangulation, the distance of the measurement device from the surface is determined, so that by means of measurements, the three-dimensional surface structure 2 of the roller 1 is detected during rotation 12 of the roller 2 over the circumference and the roller width or working width. In this regard, the press roller 1 shown in FIG. 2 can be the roller shown on the left in FIG. 1, wherein in the figures, it is not the complete rollers but rather, above all, the roller surfaces, i.e., a ring bandage of a press roller, with the roller surface, that are shown. If the analysis of the roller surface takes place in the assembled state of the press roller within the press, it is practical to carry out the measurement on the “back side” of the roller or roller surface, which lies opposite the roller gap, as indicated in FIG. 2.

In the exemplary embodiment shown, the source 9, for example the laser 8 of the monitoring device 4, projects a strip-shaped line, for example a laser line, having a measurement region M, i.e., a measurement width M, which extends along the width of the roller (i.e., axis-parallel), onto the surface of the roller.

This measurement width M is less, in the exemplary embodiment, than the working width b of the roller. Preferably, the measurement apparatus is configured as a line scanner, so that a height profile (which is two-dimensional) is at first detected by way of the line. By means of the rotation 12 of the roller 1, and consequently by means of movement of the roller surface relative to the measurement device, the complete three-dimensional structure is essentially imaged by stringing together the individually recorded line-shaped height profiles.

On the surface of the roller, and thereby within the three-dimensional surface structure 1 of the roller 2, a three-dimensional reference means 5 is affixed. This reference means 5 can be seen in an enlarged representation in a top view, as an example. The step-shaped geometry can be seen, as can an asymmetrical corner region 6 that serves for recognizing the rotation direction of the roller 2. The reference means 5 is also detected by the monitoring apparatus 4 during the distance measurements, since it is positioned within the measurement region M. In this way, perfect scaling of the data, independent of the positioning of the monitoring device, and, in addition, simple and reliable analysis over a working width b is made possible, which width is greater than the measurement width M of the measurement device. This is because the reference means 5 is attached to the roller surface in an overlap region of measurements carried out in two consecutive width regions. Since the working width b of the roller 2 is greater than the measurement width M of the monitoring apparatus 4, multiple distance measurements must be carried out over the working width b, one after the other, which measurements are then combined in the evaluation, as a three-dimensional record of the complete roller surface, to form an image or a data set, so as to represent the entire roller surface. In this regard, multiple measurements are carried out overlapping one another. A three-dimensional reference means 5 is situated, in each instance, in the overlap regions, and is also recorded by the monitoring device 4 when the distance measurements are carried out.

Within the scope of the invention, it is consequently of importance that the geometry of the reference means 5 in the X direction, Y direction, and Z direction is known, in each instance, and stored in memory in the monitoring device as a reference data set. In this regard, the X direction refers to the direction along the roller width, parallel to the roller axis, the Y direction is the direction along the roller circumference, i.e., the tangential direction, and the Z direction is the height direction, which consequently runs in the radial direction. During measuring of the roller surface, consequently not only the three-dimensional structure of the roller surface, but also, in particular, the reference means 5 is measured using the monitoring device, and detected on the basis of its specific asymmetry, for example. By means of measuring the reference means 5, what is called a scaling data set is produced, which set varies – with reference to the reference data set previously stored in memory – depending on the positioning of the monitoring device 4 relative to the roller surface. This recording of the scaling data set, which can also be referred to as a standardization data set, makes it possible, during the evaluation, to compensate the positioning of the measurement device relative to the surface of the roller 2, which positioning might vary. Thus, in particular, measurements that are carried out one after the other can be standardized independent of the positioning of the monitoring device 4. Consequently, it does not matter if, in measurements that are carried out one after the other, the distance and/or the angle of the monitoring device 4, i.e., of the sensor relative to the roller 2 is identical. If the geometry of the reference means 5 is known in every image data set, all the angle and size distortions can be calculated out by means of different orientations or distances of the measurement device 4 from the roller, so that an image of the entire roller, which image is true to dimensions and angles, is produced.

With the measurements described, taking into consideration the reference means 5 arranged in the wear region, it is possible to produce planar images, true to dimensions and angles, of the roller surfaces in the X, Y, and Z direction. From the height differences in the Z direction, it is possible to determine the wear in the Z direction, specifically relative to image points or regions of the same surface. However, in order to also be able to analyze the absolute wear of the roller surface, a reference device 7 is additionally provided in a particularly preferred embodiment, which device is arranged outside of the wear region. In this regard, it is practical to indicate the absolute wear of the roller surface relative to the roller axis, i.e., the distance of the corresponding image points of the 3D image data set from the roller axis 13. In order to be able to determine this distance data set as a wear vector field, the additional reference device 7 is arranged outside of the wear region of the roller 2, wherein its position, in particular its distance in the Z direction, from the corresponding roller axis is known. Taking into consideration the additional measurement of this reference device 7, it is possible to have all the data sets relate to the roller axis 13 in the evaluation, and thus to determine the absolute distance of all the surface points from the roller axis 13. In this way, the absolute wear, i.e., the diameter reduction of each point on the roller surface, can be determined.

In FIG. 2, the additional reference device 7 is indicated. This device is arranged, in the present representation, on the end face, i.e., flank of the roller 2. However, it can also be provided in an edge region on the roller circumference. Fundamentally, placement is also possible – at least in the case of the fixed roller – in any suitable position on the press frame. Placement on the roller itself, however, is advantageous, above all in the case of the loose roller of the press, because in this case, the position of the loose roller and thereby also of the roller axis relative to the press frame varies.

The reference device 7 consequently serves, in the manner described, for carrying out absolute measurements of the surface structure 1, and it is therefore arranged, in every case, outside of the wear region and consequently of the working region of the roller 2. In this regard, the reference device 7 is detected using the same monitoring device, i.e., the same sensor device as the reference means 5, i.e., using the same device.

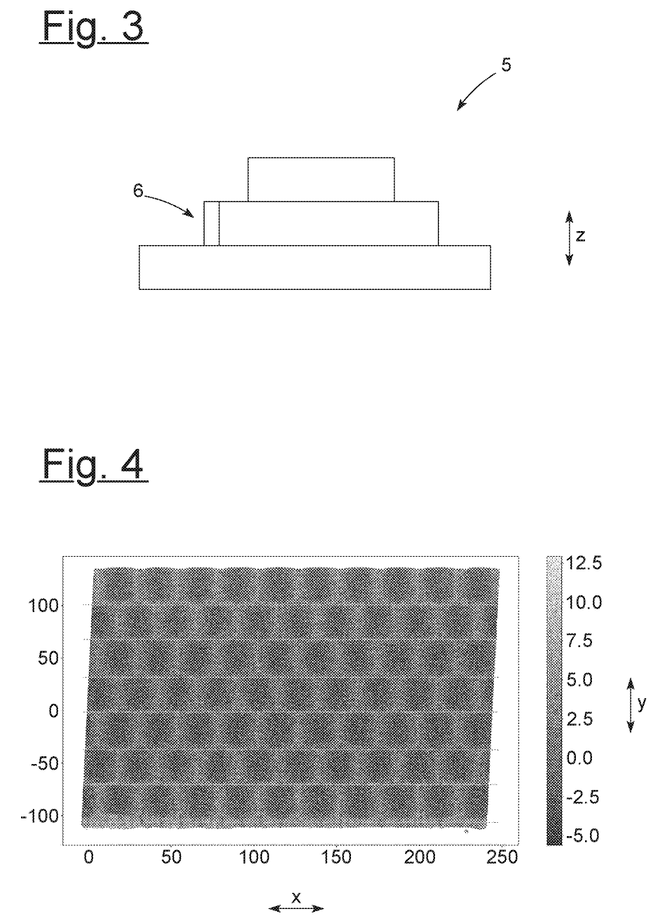

In FIG. 3, a possible embodiment of a three-dimensional reference means 5 is shown schematically, in cross-section. In this regard, the reference means 5 is configured as a step-shaped pyramid. This pyramid has multiple steps. These steps possess the same height in the present example, but can also have different heights. The width of the individual steps can vary, for example it decreases from the bottom to the top (toward the tip of the reference means 5). One of the steps has a geometrically different outline 6, so that its identification or distinction can be clearly determined by further reference means 5 and/or the orientation of this reference means 5 relative to the roller 2.

Finally, FIG. 4 shows, as an example, a three-dimensional representation of the surface structure 1 of a roller 2, determined using the method according to the invention. This representation corresponds to the record that is produced from the data obtained by the monitoring device 4 (from the corresponding distance measurements) with an evaluation unit and the scaling/standardization as described. The different gray levels are assigned, in each instance, to different heights / depths of the profile. In FIG. 4, the representation of the different briquette depressions of a briquetting roller can be seen. The gray levels consequently represent the Z direction. The darker the region is shown, the deeper the structure, i.e., the greater the distance from the measurement device. In FIG. 4, one can recognize the darker and deeper depressions as well as the brighter ridges, which thereby project upward, and delimit the individual depressions and thereby form the briquettes. If, in addition, a reference device 7 is used when carrying out the measurements, absolute values for the profile of the surface can be determined from this representation, i.e., from the measurement data on which the representation is based.

Although only a few embodiments of the present invention have been shown and described, it is to be understood that many changes and modifications may be made thereunto without departing from the spirit and scope of the invention.

What is claimed is:

1. A method for monitoring a three-dimensional structure of a surface of a roller for a roller press for comminuting, briquetting or compacting, comprising:
determining with a monitoring device a surface structure of the roller by means of distance measurements, as at least one 3D image data set,
wherein during the distance measurements, at least one three-dimensional reference means is affixed within a working width (b) of the roller, on the surface of the roller.

2. The method according to claim 1, wherein a three-dimensional geometry of the at least one three-dimensional reference means is stored in a memory as a reference data set, wherein during measurement of the roller surface, the distance measurements are carried out on the three-dimensional reference means, and a scaling measurement data set is produced from the distance measurements of the three-dimensional reference means, and wherein the 3D image data set that represents the surface structure of the roller is scaled, taking into consideration the reference data set stored in memory and the scaling measurement data set.

3. The method according to claim 1, wherein the at least one three-dimensional reference means is releasably affixed to the roller.

4. The method according to claim 1, wherein the method is carried out outside of production operation of the roller press, in a state when the roller is installed in the roller press.

5. The method according to claim 1, wherein the roller rotates during monitoring of the three-dimensional surface structure.

6. The method according to claim 1, wherein the 3D image data set is produced by means of the distance measurements over a circumference and at least over a part of the working width (b) of the roller.

7. The method according to claim 1, wherein the monitoring device has at least one sensor device, wherein the sensor device has a source that produces at least one measurement beam, and wherein the sensor device has at least one detector that detects the measurement beam that is produced by the source and reflected by the surface of the roller.

8. The method according to claim 7, wherein the measurement beam is an electromagnetic beam.

9. The method according to claim 7, wherein the source projects the measurement beam as a measurement line that is oriented along the roller width onto the roller surface, wherein a length of the measurement line that extends along the roller width defines the measurement width (M) of the sensor device.

10. The method according to claim 1, wherein the distance measurements are carried out by means of triangulation.

11. The method according to claim 2, wherein the monitoring device has a measurement width (M) that is less than the working width (b) of the roller, wherein in order to record an entire working width (b) of the roller, multiple distance measurements are carried out one after the other over the working width (b) of the roller, and thereby multiple 3D image data sets are produced,
wherein the multiple distance measurements overlap in at least one overlap region, in which the at least one reference means is arranged, and
wherein the multiple 3D image data sets that are produced over the working width are combined, taking into consideration the reference data set that is stored in memory with regard to each of the reference means and the scaling data set that is recorded at the each of the reference means, and scaled identically.

12. The method according to claim 1, wherein the monitoring device is mounted in a fixed location during monitoring of the three-dimensional surface structure during the measurement over a measurement width (M).

13. The method according to claim 12, wherein the monitoring device is positioned in different positions relative to the roller, for measuring a working width (b) that is greater than the measurement width (M), one after the other.

14. The method according to claim 1, wherein the at least one three-dimensional reference means is configured as a step-shaped reference means in cross-section.

15. The method according to claim 1, wherein the at least one three-dimensional reference means is configured to be asymmetrical in a top view.

16. The method according to claim 1, wherein a plurality of the three-dimensional reference means are arranged distributed on the surface of the roller, over the working width (b), at a distance from one another.

17. The method according to claim 1, wherein for an absolute measurement of the surface, at least one reference device is provided outside of the working width (b) of the roller, which reference device is positioned at a defined distance from the roller axis.

18. An apparatus for monitoring a three-dimensional structure of a surface of a roller for a roller press for comminuting, briquetting or compacting material, to carry out the method according to claim 1, the apparatus comprising a monitoring device and at least one three-dimensional reference means, wherein the at least one three-dimensional reference means is configured to be attached within the working width (b) of the roller, on the surface of the roller.

19. The apparatus according to claim 18, wherein the monitoring device has at least one sensor device, wherein the sensor device has a source configured for producing a measurement beam, and wherein the sensor device has a detector that is configured to detect the measurement beam that is produced by the source and reflected by the surface of the roller.

20. The apparatus according to claim 19, wherein the monitoring apparatus or the sensor device is configured to be mobile or transportable.

21. The apparatus according to claim 18, further comprising an evaluation unit that is integrated into the monitoring device as an internal evaluation unit or connected to the monitoring device as an external evaluation unit and/or communicates with the the monitoring device, wherein the reference data set is stored in memory in the internal evaluation unit or the external evaluation unit, for scaling of the 3D image data set.

22. The apparatus according to claim 19, wherein the source is configured to produce electromagnetic radiation, and/or wherein the sensor device is configured as a line scanner, wherein using the source, a measurement line that extends along the roller width is projected onto the roller surface.

23. A roller press system comprising a roller press having two rollers mounted to rotate in a press frame, between which rollers a roller gap is formed, and the apparatus for monitoring according to claim 18, wherein the at least one reference means is configured to be affixed to the surface of this roller, within the working width (b) of one of the rollers.

24. The roller press system according to claim 23, wherein the roller has a regular surface structure over the width and/or a circumference.

25. The roller press system according to claim 23, wherein the roller is configured as a briquetting or compacting roller having a depression-shaped surface structure or as a comminution roller having pin-shaped or plate-shaped wear-protection elements.
